(19) United States
(12) Patent Application Publication
(10) Pub. No.: US 2026/0147218 A1
(43) Pub. Date: May 28, 2026

(54) DISPLAY DEVICE FOR USE IN FRONT OF A USER’S EYES

(71) Applicant: CANON KABUSHIKI KAISHA, Tokyo (JP)

(72) Inventors: AKIHITO TAKETANI, Tokyo (JP); TAKASHI TORII, Kanagawa (JP)

(21) Appl. No.: 19/456,586

(22) Filed: Jan. 22, 2026

Related U.S. Application Data
(63) Continuation of application No. PCT/JP2024/015208, filed on Apr. 17, 2024.

(30) Foreign Application Priority Data
Jul. 25, 2023 (JP) 2023-120499

(51) Int. Cl. G02B 27/01

(52) U.S. Cl. CPC G02B 27/0176; G02B 27/0172; G02B 2027/0123; G02B 2027/0138; G02B 2027/0154

(57) ABSTRACT

A display device includes a body portion including a camera and a display, and a holding portion having a shape that forms a gap with left and right ends of the body portion, wherein the holding portion is a handle portion gripped by a hand of a user, the camera is provided on a side of a first surface of the display device, the display is provided on a side of a second surface that is a surface opposite to the first surface of the display device, and a length of the holding portion is 50 mm or more in a direction from the first surface toward the second surface.

### CROSS-REFERENCE TO RELATED APPLICATIONS

This application is a Continuation of International Patent Application No. PCT/JP 2024/015208, filed Apr. 17, 2024, which claims the benefit of Japanese Patent Application No. 2023-120499, filed Jul. 25, 2023, both of which are hereby incorporated by reference herein in their entirety.

### BACKGROUND

### Field of the Technology

The present disclosure relates to a display device used while being disposed in front of a user's eyes, and particularly relates to a configuration for maintaining an unobstructed peripheral visual field.

### Description of the Related Art

A head-mounted display (HMD) mounted on the head of a user and a handheld display (HHD) held by the hand of the user are known as display devices used while being disposed in front of the user's eyes. In order to improve a sense of immersion in virtual reality (VR) or mixed reality (MR), these display devices are often configured to cover both the eyes of the user with the display device disposed in front of the user's eyes.

When both the eyes of the user are covered, the sense of immersion is improved, but it does not allow the user to perceive danger in the surroundings. Japanese Patent Laid-Open No. 2019-125965 discloses a display device that is configured to maintain an unobstructed peripheral visual field of a user in a state where the display device is disposed in front of the user's eyes. The user's peripheral visual field remains unobstructed, and thus, the sense of immersion is decreased but safety is increased (the user is allowed to sense the danger in the surroundings). In addition, improvement of the mixed reality can be expected by continuity between the peripheral visual field and a video.

In order to hold the display device in front of the user's eyes, the display device may be connected to a holding member. Japanese Patent Laid-Open No. 2019-125965 and Japanese Patent Laid-Open No. 2016-171461 disclose a technology in which a display device is connected to a holding member and used as an HMD or an HHD.

However, in the related art disclosed in Japanese Patent Laid-Open No. 2016-171461 and the related art disclosed in Japanese Patent Laid-Open No. 2021-114756, maintenance of an unobstructed peripheral visual field is not considered. Thus, the user's peripheral visual field is not maintained unobstructed, and the user may not be able to sense the danger in the surroundings. In the related art disclosed in Japanese Patent Laid-Open No. 2019-125965, maintenance of an unobstructed peripheral visual field is considered, but the connection of the display device to the holding member is not considered. Thus, in a state where the display device is connected to the holding member, the user's peripheral visual field is not maintained unobstructed, and the user may not be able to sense the danger in the surroundings. In the HHD, the user's peripheral visual field may be covered by the hand of the user.

### SUMMARY

The present disclosure provides a display device that maintains an unobstructed peripheral visual field of a user in a state where a display device connected to a holding member (or a display device including a portion corresponding to the holding member) is disposed in front of the user's eyes.

A display device according to the present disclosure is used while being disposed in front of eyes of a user, the display device including a body portion including a camera configured to capture a real space and a display configured to display a video of the real space captured by the camera, and having a shape configured to maintain an unobstructed peripheral visual field of the user in a state of being disposed in front of the eyes of the user, and a holding portion having a shape that forms a gap with left and right ends of the body portion so as not to block a portion adjacent to the left and right ends of the body portion in the peripheral visual field of the user, wherein the holding portion is a handle portion gripped by a hand of the user, the camera is provided on a side of a first surface of the display device, the display is provided on a side of a second surface that is a surface opposite to the first surface of the display device, and a length of the holding portion is 50 mm or more in a direction from the first surface toward the second surface.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a display device according to a first embodiment.

FIG. 2 is a perspective view of a headband-type mounting member according to the first embodiment.

FIG. 3 is a perspective view illustrating a connection state according to the first embodiment.

FIG. 4 is a perspective view illustrating a connection state according to a second embodiment.

FIG. 5 is a perspective view illustrating the connection state according to the second embodiment.

FIG. 6 is a perspective view of a display device according to a third embodiment.

FIG. 7 is a perspective view of a handheld member according to the third embodiment.

FIG. 8 is a perspective view illustrating a connection state according to the third embodiment.

FIG. 9 is a sectional view of the connection state according to the third embodiment.

FIG. 10 is a perspective view illustrating a comparative example of the connection state.

FIG. 11 is a sectional view illustrating the comparative example of the connection state.

FIG. 12 is a perspective view of a display device according to a fourth embodiment.

FIG. 13 is a perspective view of a handheld member according to the fourth embodiment.

FIG. 14 is a perspective view illustrating a connection state according to the fourth embodiment.

FIG. 15 is a sectional view illustrating the connection state according to the fourth embodiment.

### DESCRIPTION OF THE EMBODIMENTS

### First Embodiment

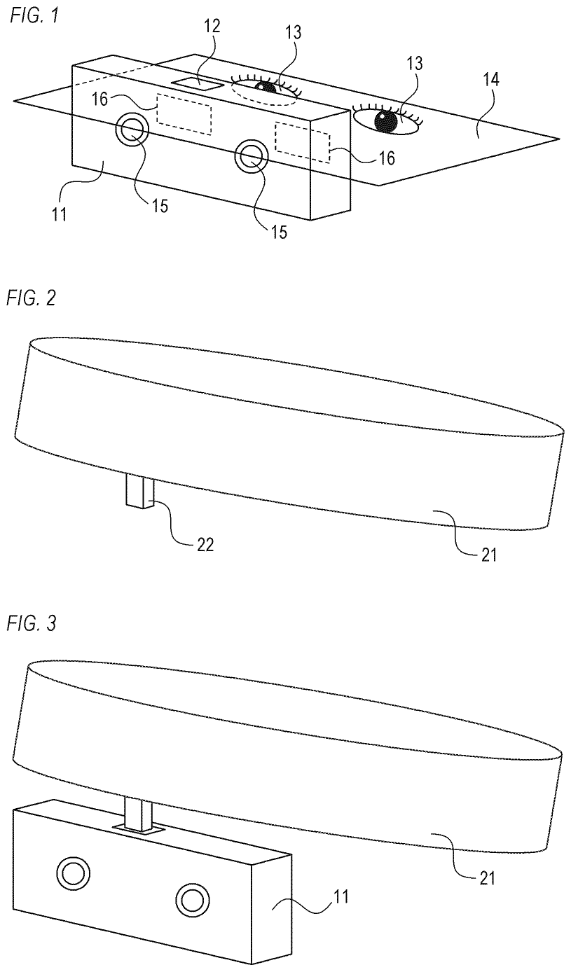

Hereinafter, a first embodiment of the present disclosure will be described with reference to FIGS. 1 to 3.

FIG. 1 is a perspective view of a display device 11 according to the first embodiment. A user uses the display device 11 while disposing the display device in front of the user's eyes. Thus, when the user uses the display device 11, eyes 13 of the user are disposed on a back surface side of the display device 11. The display device 11 includes a display unit 16 (display) on the back surface side. In a state where the display device 11 is disposed in front of the eyes 13, the display unit 16 projects a video onto the eyes 13. The display unit 16 includes, for example, a display panel such as a liquid crystal panel or an organic EL panel, and a prism (eyepiece optical system) that projects a video displayed on the display panel onto the eyes 13. The display unit 16 may be a retinal projection type display unit.

The display device 11 includes, at an upper portion, a connection portion 12 (connection structure) with a holding member that holds the display device 11. A plane 14 is a horizontal plane on which an optical axis of the display unit 16 (eyepiece optical system) is positioned, and the connection portion 12 is provided above the plane 14. The plane 14 may be interpreted as the horizontal plane on which a center of the video projected on the eyes 13 is positioned. Further, the display device 11 includes an imaging unit 15 (camera) that captures an image of a real space on a front surface side. The imaging unit 15 is used, for example, to estimate a position and a posture of the display device 11. The display unit 16 may project a video of the real space captured by the imaging unit 15 onto the eyes 13. Note that, the display device 11 may not include the imaging unit 15.

FIG. 2 is a perspective view of a headband-type mounting member 21 as an example of the holding member that holds the display device 11. The user connects the display device 11 to the mounting member 21, and mounts the mounting member 21 on the head. Consequently, the display device 11 is disposed in front of the eyes 13. The mounting member 21 includes a connection portion 22 with the display device 11. The mounting member 21 may include a power supply or an image processing device. The mounting member 21 may include a cable for wired connection with an external device or may include a communication device for wireless connection with an external device.

FIG. 3 is a perspective view illustrating a state where the display device 11 is connected to the mounting member 21. The connection portion 12 of the display device 11 is connected to the connection portion 22 of the mounting member 21. Consequently, the display device 11 is electrically and physically connected to the mounting member 21. The display device 11 is connected to the mounting member 21, and thus, power is supplied from the mounting member 21 to the display device 11 via the connection portions 22 and 12. For example, power is supplied from the power supply (internal power supply) of the mounting member 21 to the display device 11, or power is supplied from an external device (external power supply) connected to the mounting member 21 to the display device 11 via the mounting member 21. The display device 11 is driven by the power supplied from the mounting member 21 (performs a main operation). The display device 11 may include a power supply such as a small secondary battery. The electrical or physical connection between the display device 11 and the mounting member 21 may be performed supplementarily (additionally) at a portion different from the connection portions 12 and 22.

As described above, according to the first embodiment, the connection portion 12 with the mounting member 21 is provided at the upper portion of the display device 11, and the display device 11 is connected to the mounting member 21 so as to be suspended from the mounting member 21. Then, the display device 11 has a shape configured to maintain an unobstructed peripheral visual field of the user (shape that does not cover the eyes 13) in a state where the display device 11 is disposed in front of the eyes 13 of the user. Consequently, even in a state where the display device 11 connected to the mounting member 21 is disposed in front of the eyes 13 (a state where the mounting member 21 to which the display device 11 is connected is mounted on the head of the user), the user's peripheral visual field can be kept unobstructed in the left, right, and lower directions.

Note that, in a case where a danger in an upper direction is to be sensed rather than a danger in the lower direction, the connection portion with the holding member may be provided at a lower portion (for example, below the optical axis of the eyepiece optical system) of the display device. Consequently, even in a state where the display device connected to the holding member is disposed in front of the user's eyes, the user's peripheral visual field can be kept unobstructed in the left, right, and upper directions. In many cases, since it is desirable to be able to sense a danger in a left-right direction, a peripheral visual field in the left-right direction is kept unobstructed.

### Second Embodiment

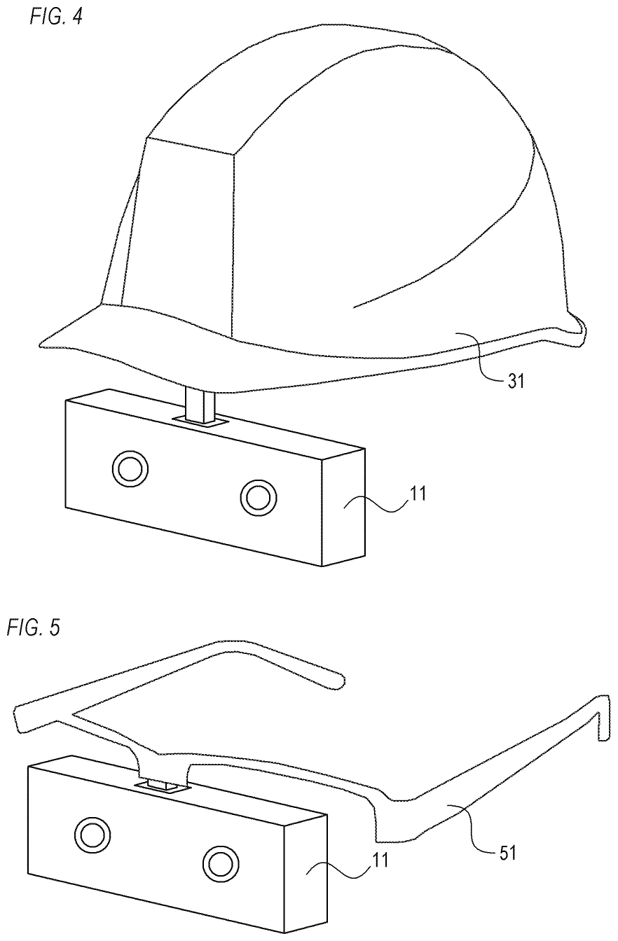

Hereinafter, a second embodiment of the present disclosure will be described with reference to FIGS. 4 and 5. Note that, in the following description, the same points as in the first embodiment (for example, the same configurations as in the first embodiment) will not be described, and different points from the first embodiment will be described.

FIG. 4 is a perspective view illustrating a state where the display device 11 is connected to the holding member. In FIG. 4, the holding member is a helmet-type mounting member 31. The mounting member 31 can be suitably used in a scene where safety of the head of the user is regarded as important. A load on the user is smaller when the helmet-type mounting member 31 is used than when a helmet is worn on the head after the headband-type mounting member is mounted.

FIG. 5 is a perspective view illustrating a state where the display device 11 is connected to the holding member. In FIG. 5, the holding member is a glasses-type mounting member 41. The mounting member 41 can be suitably used in a scene where portability or comfort in long-term use is regarded as important.

As described above, similarly to the first embodiment, in the second embodiment, even in a state where the display device connected to the holding member is disposed in front of the user's eyes, the user's peripheral visual field can also be kept unobstructed in the left, right, and lower (or upper) directions. Note that, the holding member is not limited to the holding member described above, and various holding members can be used in accordance with a use method or a use environment.

### Third Embodiment

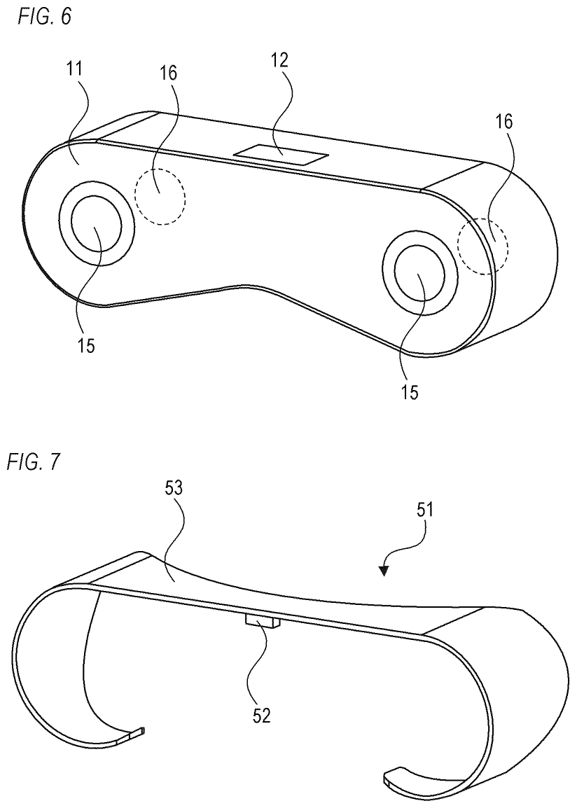

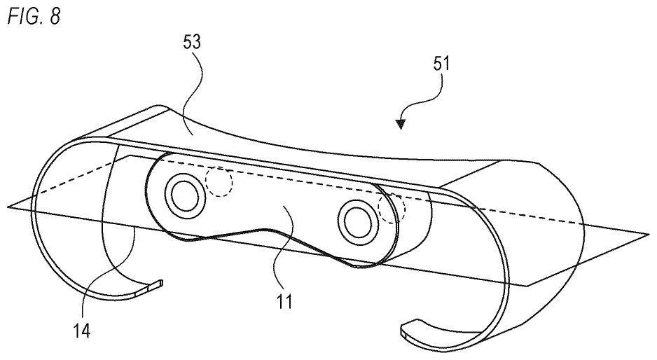

Hereinafter, a third embodiment of the present disclosure will be described with reference to FIGS. 6 to 11. Note that, in the following description, the same points as in the first embodiment (for example, the same configurations as in the first embodiment) will not be described, and different points from the first embodiment will be described.

FIG. 6 is a perspective view of a display device 11 according to the third embodiment. FIG. 7 is a perspective view of a handheld member 51 as an example of the holding member that holds the display device 11. The user connects the display device 11 to the handheld member 51 and grips the handheld member 51 with their hand. The handheld member 51 includes a base portion 53 to be gripped by the hand of the user and a connection portion 52 with the display device 11. The display device 11 may be interpreted as a body portion, the handheld member 51 may be interpreted as a handle portion, and a combination of the display device 11 and the handheld member 51 may be interpreted as a display device.

FIG. 8 is a perspective view illustrating a state where the display device 11 is connected to the handheld member 51. The connection portion 12 provided at the upper portion of the display device 11 is connected to the connection portion 52 of the handheld member 51. Consequently, the display device 11 is electrically and physically connected to the handheld member 51. The display device 11 is connected to the handheld member 51, and thus, power is supplied from the handheld member 51 to the display device 11 via the connection portions 52 and 12. For example, power is supplied from a power supply (internal power supply) of the handheld member 51 to the display device 11, or power is supplied from an external device (external power supply) connected to the handheld member 51 to the display device 11 via the handheld member 51. The display device 11 is driven by the power supplied from the handheld member 51 (performs main operation). The display device 11 may include a power supply such as a small secondary battery. The electrical or physical connection between the display device 11 and the handheld member 51 may be performed supplementarily (additionally) at a portion different from the connection portions 12 and 52.

In the third embodiment, the connection portion 12 with the handheld member 51 is provided at the upper portion of the display device 11, and the display device 11 is connected to the handheld member 51 so as to be suspended from the handheld member 51. The display device 11 has a shape configured to maintain an unobstructed peripheral visual field of the user (shape that does not cover the eyes 13) in a state where the display device 11 is disposed in front of the eyes 13 of the user. The handheld member 51 has a shape that forms gaps with left and right ends of the display device 11 so as not to block the user's peripheral visual field in the left-right direction in a state where the display device 11 is connected. Then, the handheld member 51 has a shape that keeps a lower side of the display device 11 unobstructed in a state where the display device 11 is connected to the handheld member 51. Consequently, even in a state where the display device 11 connected to the handheld member 51 is disposed in front of the user's eyes, the user's peripheral visual field can also be kept unobstructed in the left, right, and lower directions.

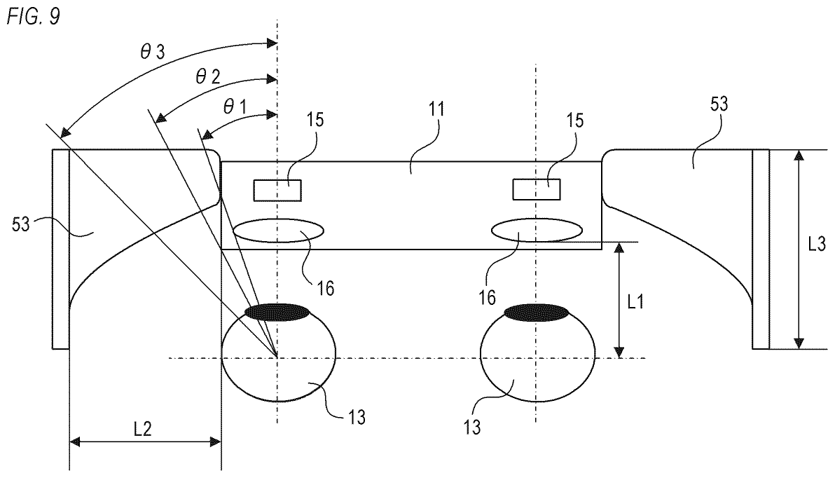

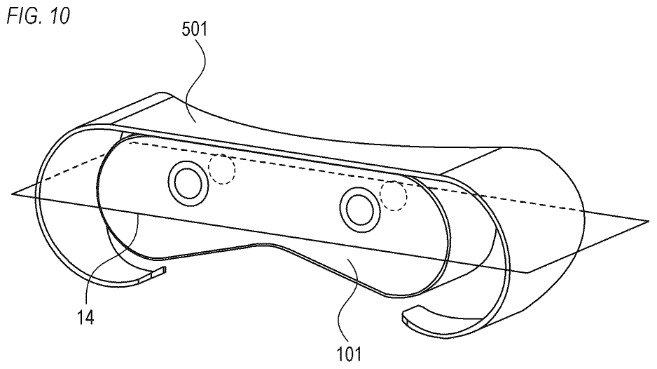

The gaps (spaces) between the handheld member 51 and the left and right ends of the display device 11 will be described with reference to FIG. 9. FIG. 9 is a sectional view illustrating a section obtained by the plane 14 in FIG. 8 (horizontal plane on which the optical axis of the display unit 16 (eyepiece optical system) is positioned). In FIG. 9, the eyes 13 are positioned on the optical axis of the display unit 16.

A distance L1 is an eyepiece distance of the user with respect to the display device 11, and is, for example, a distance from the display unit 16 to a center of the eyes 13. The distance L1 may be a distance obtained by adding a distance (generally 10 mm) from a pupil position of the eye 13 to a center of rotational motion to an eye relief of the display unit 16. A distance L2 is a length of the gap on the plane 14, and is a distance from a left end of the display device 11 to a left end (inner wall) of the handheld member 51. The distance L2 is also a distance from a right end of the display device 11 to a right end (inner wall) of the handheld member 51. A distance L3 is a length of the handheld member 51 in a front-back direction.

Angles θ1 to θ3 are angles in a line-of-sight direction of the user with respect to the optical axis of the display unit 16 (eyepiece optical system). The angle θ1 is an angle when the user visually recognizes a left end (or right end) of a video, and is an angle that is substantially half an angle of view of the video. The angle θ1 is an angle at which shielding by the display device 11 starts. The angle θ2 is an angle when the user visually recognizes the left end (or right end) of the display device 11. The angle θ2 is an angle at which shielding by the display device 11 ends. The angle θ3 is an angle when the user visually recognizes the left end (or right end) of the handheld member 51. The angle θ3 is an angle at which shielding by the handheld member 51 starts.

Since the angle θ3 is larger than the angle θ2, the user can visually recognize the surroundings through the gap between the display device 11 and the handheld member 51. Since the user grips the outside of the handheld member 51, the user does not obstruct the user's peripheral visual field with their hand.

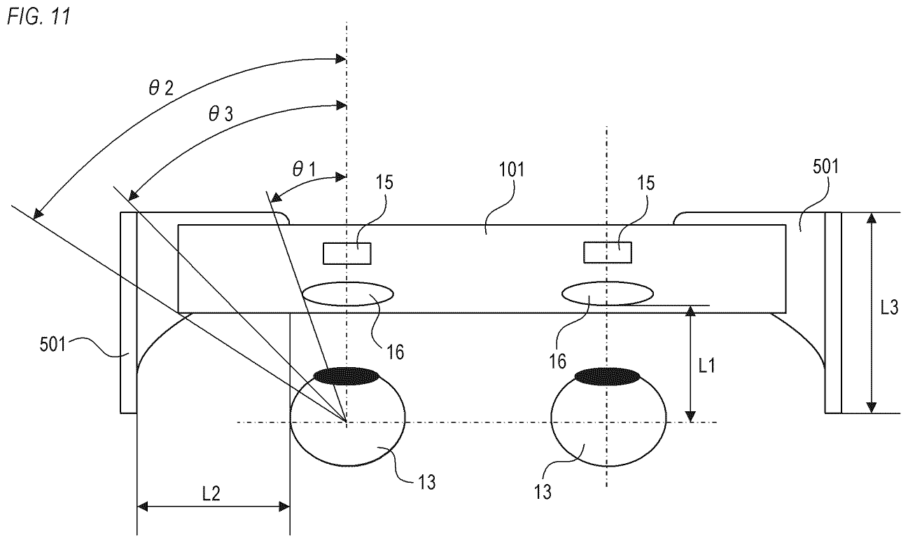

FIGS. 10 and 11 are diagrams illustrating a comparative example. FIG. 10 is a perspective view illustrating a state where the display device 101 is connected to the handheld member 501. FIG. 11 is a sectional view illustrating a section obtained by the plane 14 in FIG. 10 (horizontal plane on which the optical axis of the display unit (eyepiece optical system) is positioned). FIGS. 10 and 11 are similar to FIGS. 8 and 9, but the angle θ3 is smaller than the angle θ2. Thus, the user cannot visually recognize the surroundings through the gap between the display device 101 and the handheld member 501.

As described above, in the third embodiment, in a state where the display device connected to the holding member is disposed in front of the user's eyes, the user's peripheral visual field can also be kept unobstructed in the left, right, and lower directions.

Note that, the handheld member 51 may include a power supply or an image processing device. The handheld member 51 may include a cable for wired connection with an external device or may include a communication device for wireless connection with an external device. In a case where the handheld member 51 includes the cable, the handheld member 51 preferably has a shape that guides the cable. The handheld member 51 may include a cable that functions as the connection portion 52.

The distance L3 is preferably 50 mm or more such that a width from a second finger to a fifth finger of the user falls within the distance L3 that is the length of the handheld member 51 in the front-back direction. Consequently, it is possible to prevent the finger of the user (for example, fifth finger) from entering the peripheral visual field.

When the effective visual field of the human eye is considered, the angle θ3 at which the shielding by the handheld member 51 starts is preferably 30 degrees or more. That is, the blocking-start angle in the left-right direction caused by the handheld member 51 is 30 degrees or greater relative to the optical axis of the eyepiece optical system.

Preferably, the handheld member 51 is connected to the display device 11 so as to enclose the display device 11, and the display device 11 does not protrude from the handheld member 51 in six directions of upper, lower, front, back, left, and right. That is, preferably, the display device 11 is accommodated in a space inscribed in the handheld member 51 in a state where the display device 11 is connected to the handheld member 51. Consequently, when the display device 11 to which the handheld member 51 is connected is dropped or placed on the floor, since the handheld member 51 hits the floor before the display device 11, the display device 11 can be protected. Although the entire handheld member 51 may protrude from the display device 11, the handheld member 51 may partially include a protrusion such that a part of the handheld member 51 protrudes from the display device 11. As a result, the user's peripheral visual field can be kept unobstructed.

A difference (θ2−θ1) between the angle θ1 at which the shielding by the display device 11 starts and the angle θ2 at which the shielding by the display device 11 ends is preferably small. In a case where the video of the real space is displayed, as the difference (θ2−θ1) is smaller, the user is more likely to feel continuous connection between the video and the peripheral visual field.

### Fourth Embodiment

Hereinafter, a fourth embodiment of the present disclosure will be described with reference to FIGS. 12 to 15. Note that, in the following description, the same points as in the third embodiment (for example, the same configurations as in the third embodiment) will not be described, and different points from the third embodiment will be described.

FIG. 12 is a perspective view of a display device 11 according to the fourth embodiment. The display device 11 includes, at the upper portion, a positioning portion 17 (positioning structure) for positioning with the holding member separately from the connection portion 12.

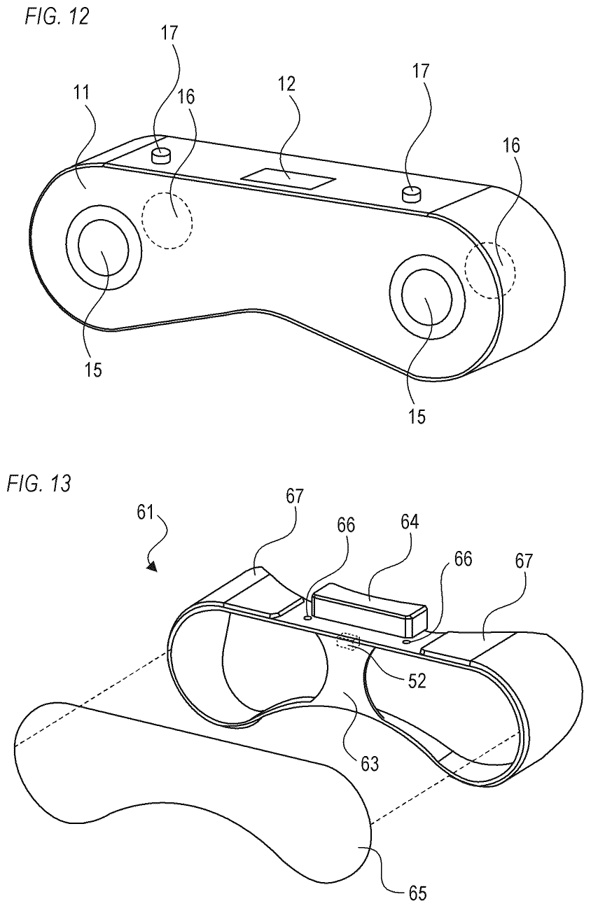

FIG. 13 is a perspective view of a handheld member 61 as an example of the holding member that holds the display device 11. The handheld member 61 includes a connection portion 52, a base portion 63, a face contact portion 64 (face contact structure), a filter 65, a positioning portion 66, and a non-slip portion 67. The handheld member 61 (base portion 63) is different from the handheld member 51 (base portion 53) of the third embodiment in having a tubular shape. In addition, the base portion 63 includes an attachment surface of the filter 65. The face contact portion 64 is provided on the back surface side with respect to the base portion 63. The user brings the face contact portion 64 into contact with the forehead when the display device 11 to which the handheld member 61 is connected is used. The filter 65 covers a front surface of the handheld member 61 and protects the display device 11 connected to the handheld member 61, for example. Although the filter 65 is away from the base portion 63 in FIG. 13, the filter 65 is attached to the attachment surface of the base portion 63. The positioning portion 66 is formed at an upper portion of the base portion 63 and is used for positioning with the display device 11. The non-slip portion 67 is formed on at least a part (for example, left portion and right portion) of a surface of the handheld member 61 (base portion 63).

The positioning portions 17 and 66 are provided at positions different from the connection portions 12 and 52 in order to reduce an external force required for connection of the connection portions 12 and 52. A connection direction of the connection portion 12 and the connection portion 52 is the upper-lower direction, and the positioning portions 17 and 66 have shapes that suppress movement in directions other than the upper-lower direction.

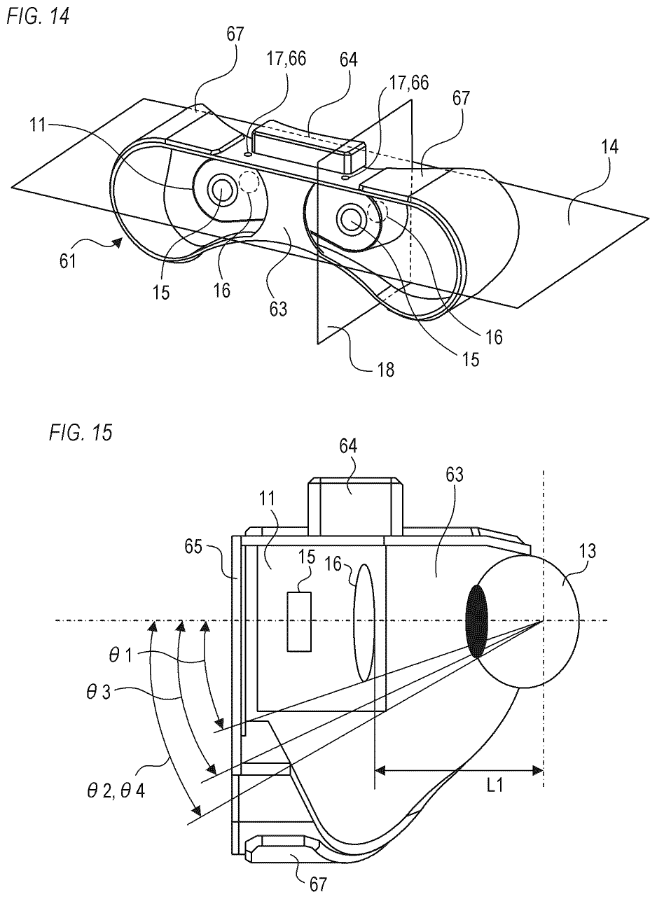

FIG. 14 is a perspective view illustrating a state where the display device 11 is connected to the handheld member 61. In FIG. 14, the filter 65 is omitted. FIG. 15 is a sectional view illustrating a section obtained by a plane 18 (vertical plane perpendicular to the plane 14) in FIG. 14. In FIG. 15, the eyes 13 are positioned on the optical axis of the display unit 16.

Angles θ1 to θ4 are angles in the line-of-sight direction of the user with respect to the optical axis of the display unit 16 (eyepiece optical system). The angle θ1 is an angle when the user visually recognizes a lower end of the video. The angle θ1 is an angle at which shielding by the display device 11 starts. The angle θ2 is an angle when the user visually recognizes a lower end of the display device 11. The angle θ2 is an angle at which shielding by the display device 11 ends. The angle θ3 is an angle when the user visually recognizes a lower end of the front surface of the handheld member 61. The angle θ3 is an angle at which shielding by the handheld member 61 starts. The angle θ4 is an angle when the user visually recognizes a lower end of a back surface of the handheld member 61. The angle θ4 is an angle at which shielding by the handheld member 61 ends.

As illustrated in FIG. 15, a lower portion of the base portion 63 is away from the eyes of the user, the angle θ3 is smaller than the angle θ2, and the angle θ4 substantially coincides with the angle θ2. Consequently, even though the base portion 63 has a tubular shape, the user's peripheral visual field can be kept unobstructed in the left, right, and lower directions. Although there is a possibility that the first finger enters the user's peripheral visual field in the lower direction, the non-slip portion 67 is provided outside the plane 18 in the left-right direction, and thus, the user naturally places the first finger at the non-slip portion 67. As a result, the entry of the first finger into the user's peripheral visual field can be suppressed.

As described above, in the fourth embodiment, in a state where the display device connected to the holding member is disposed in front of the user's eyes, the user's peripheral visual field can also be kept unobstructed in the left, right, and lower directions.

Note that, at least a part of the handheld member 61 (base portion 63) may be made of a transparent material. Accordingly, even though the angle θ4 at which the shielding by the handheld member 61 ends is larger than the angle θ2 at which the shielding by the display device 11 ends, the peripheral visual field can be kept unobstructed. In addition, at least a part of the handheld member 61 (base portion 63) may be made of an elastic material. For example, the base portion 63 partially using the elastic material may be generated by two-color molding. Consequently, the protection performance of the display device 11 can be improved.

Since the base portion 63 has the tubular shape, the display device 11 may include the connection portion 12 with the handheld member 61 at the lower portion of the display device 11.

The face contact portion 64 may be provided to be shiftable back and forth relative to the handheld member 61 (base portion 63). Consequently, the display device 11 is usable at a position better matched to the user, and convenience can be improved. Note that, the handheld member 61 may not include the face contact portion 64.

The non-slip portion 67 may be provided in any method. For example, the sheet-shaped non-slip portion 67 may or may not be attached to the base portion 63 with double-sided tape. The non-slip portion 67 is provided, and thus, it is possible to improve the stability of gripping of the handheld member 61 (the handheld member 61 to which the display device 11 is connected). Note that, the handheld member 61 may not include the non-slip portion 67.

The filter 65 may be provided in any method. For example, the filter 65 may be attached to a front surface of the base portion 63 with double-sided tape. The filter 65 may be fitted into the base portion 63. In that case, the base portion 63 may not include the attachment surface of the filter 65. The filter 65 may be a neutral density filter. As a result, it is possible to improve the visibility of the video acquired by the imaging unit 15 in a bright environment. Note that, the handheld member 61 may not include the filter 65.

To the extent that the user's peripheral visual field is not obstructed, the handheld member 61 may have a configuration for reducing an external force required for connection of the connection portion 12 and the connection portion 52. For example, two magnets that attract each other at the time of connection of the connection portion 12 and the connection portion 52 may be provided in each of the display device 11 and the handheld member 61.

Note that, the above-described embodiments (including modifications) are merely examples, and a configuration obtained by appropriately modifying or changing any of the configurations of the above-described embodiments within the scope of the gist of the present disclosure is also included in the present disclosure. A configuration obtained by appropriately combining the configurations of the above-described embodiments is also included in the present disclosure.

According to the present disclosure, the user's peripheral visual field can be kept unobstructed in a state where the display device (or a display device including a portion corresponding to the holding member) connected to the holding member is disposed in front of the user's eyes.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A display device that is used while being disposed in front of eyes of a user, the display device comprising:
a body portion including a camera configured to capture a real space and a display configured to display a video of the real space captured by the camera, and having a shape configured to maintain an unobstructed peripheral visual field of the user in a state of being disposed in front of the eyes of the user; and
a holding portion having a shape that forms a gap with left and right ends of the body portion so as not to block a portion adjacent to the left and right ends of the body portion in the peripheral visual field of the user,
wherein the holding portion is a handle portion gripped by a hand of the user,
the camera is provided on a side of a first surface of the display device,
the display is provided on a side of a second surface that is a surface opposite to the first surface of the display device, and
a length of the holding portion is 50 mm or more in a direction from the first surface toward the second surface.

2. The display device according to claim 1,
wherein the display includes an eyepiece optical system configured to project the video onto the eyes of the user.

3. The display device according to claim 1, wherein the body portion is driven by power supplied from the holding portion.

4. The display device according to claim 1,
wherein the holding portion includes a contact portion configured to contact a forehead of the user.

5. The display device according to claim 4, p1wherein the contact portion is provided so as to be shiftable back and forth.

6. The display device according to claim 1, p1wherein at least a part of the holding portion is made of a transparent material.

7. The display device according to claim 1, p1wherein at least a part of the holding portion is made of an elastic material.

8. The display device according to claim 1,
wherein a non-slip portion is formed on at least a part of a surface of the holding portion.

9. The display device according to claim 1, further comprising a filter configured to cover the gaps.

10. The display device according to claim 2,
wherein a blocking-start angle in a left-right direction caused by the holding portion is 30 degrees or greater relative to an optical axis of the eyepiece optical system.

11. The display device according to claim 1,
wherein the body portion is accommodated in a space inscribed in the holding portion.

12. A display device that is used while being disposed in front of eyes of a user, the display device comprising:
a body portion including a camera configured to capture a real space and a display configured to display a video of the real space captured by the camera; and
a holding portion configured to hold the body portion,
wherein the holding portion has a tubular shape that forms gaps between the holding portion and left and right ends of the body portion.
